(19) United States
(12) Patent Application Publication
(10) Pub. No.: US 2025/0067512 A1
(43) Pub. Date: Feb. 27, 2025

(54) MATERIALS AND METHODS TO PREVENT CHEMICAL ATTACK OF KILN SHELVES AND SAGGARS

(71) Applicant: William Carty, Alfred Station, NY (US)

(72) Inventor: William Carty, Alfred Station, NY (US)

(21) Appl. No.: 18/811,931

(22) Filed: Aug. 22, 2024

Related U.S. Application Data
(60) Provisional application No. 63/578,022, filed on Aug. 22, 2023.

(51) Int. Cl. F27D 1/00; B32B 18/00

(52) U.S. Cl. CPC F27D 1/0043; B32B 18/00; B32B 2307/7376

(57) ABSTRACT

Shelf liners and methods of using the same to protect kiln interiors from glaze running or dripping from ceramic objects being fired are disclosed. The disclosed shelf liners include a first layer made from an alumina-rich material and a second layer made from a silica-rich material. Optionally a third layer also made from an alumina-rich material is configured such that the second layer is disposed between the first and third layers. The liners are installed in kilns such that molten glaze running off of a ceramic body drips onto the first layer of the liner and is prevented from contacting the kiln shelf.

### CROSS REFERENCE TO RELATED APPLICATIONS

This application is related and claims priority to U.S. Provisional Patent Application No. 63/578,022 filed on Aug. 22, 2023, which is incorporated herein by reference.

### FIELD

The claimed technology relates generally to ceramics and more particularly to the prevention of molten liquids, such as from glaze materials, from damaging kiln shelving and saggars.

### BACKGROUND

Ceramic bodies, both functional and sculptural pieces, are frequently glazed to add to the esthetics and function. Glazes are typically composed of compositions that melt during the heat treatment process and form a glass on cooling. These compositions are engineered to melt at the desired heat treatment or firing temperature. It is not uncommon, however, for glazes to melt at temperatures lower than required, causing the glaze to flow, or run, down the side of the piece. A low viscosity liquid (glass) moves faster and a greater distance than a high viscosity glass. If the glaze flows a lot, the glass can run off the piece and onto kiln surfaces such as shelves. On cooling, this liquid solidifies to form a glass that glues the piece to the kiln shelf, frequently also causing corrosive damage to the kiln shelf.

The corrosive attack of the glaze may damage the kiln shelf or other surfaces the glaze contacts. The glass and the reaction products formed by reaction with the kiln shelf are remarkably strong requiring chiseling (a less than preferred means of removing the glassy drip) or, as is common, grinding off the glass with an abrasive wheel before the shelf can be used again. If the kiln shelf is re-used without removing the damage and residual glass from the kiln shelf, the residual glass may remelt and glue the next piece to the kiln shelf in the same region on the next firing. The grinding of kiln shelves, and the damage to pieces, is a problem that affects almost all studio potters and academic ceramic art programs, as well as many arenas in the ceramic manufacturing industry. It is expensive, time consuming, causes damage to the kiln shelf, and potentially poses a health risk from the dust created by grinding.

To eliminate the problem of “glaze drips” it is common to coat a kiln shelf with a “kiln wash”, a mixture of clay and alumina (either hydrated alumina or calcined alumina) typically in the range of 10-30% clay with the balance alumina. In some cases, zircon is also included in a wash, either in addition to or replacing alumina. Such suspensions are used to coat the kiln shelves prior to firing. Sometimes a coating of kiln wash can be used again, often several times, if the glaze drips are not severe and the kiln wash remains intact. The problem with typical kiln wash compositions is that the alumina solubility in a low viscosity glass is limited and thus current kiln wash compositions provide only marginal protection against kiln shelf attack from glaze drips. There remains a need for materials and methods of protecting kiln interiors and shelves from runoff or dripping glaze material while firing glazed ceramic bodies.

### SUMMARY

In one aspect, a laminated ceramic sheet is fabricated for lining a kiln shelf for preventing glaze drips from transferring from a glazed object being fired to the kiln shelf having a first layer made from an alumina-rich material and a second layer made from a silica rich material where the second layer is at least a similar thickness to the first layer, preferably 3× thicker than the first layer and up to 40× thicker than the first layer. The alumina-rich material may be a mixture of clay and calcined alumina containing 75-95% calcined alumina. Optionally, the alumina-rich material may further include an organic polymer binding agent. The silica-rich material may be a mixture of clay and quartz containing 50-90% quartz. Optionally, the silica-rich material may further include an organic polymer binding agent. Optionally, the liner may further include a third layer which is also made from a similar alumina-rich material as the first layer and which is disposed such that the second layer is sandwiched between the first and third layers. In some examples dopants may be added to the material of the first and/or third layers.

In another aspect, a liner material for a kiln shelf, the liner having at least a first layer made from a calcium carbonate-rich material and a second layer made from a silica-rich material where the second layer is at least as thick as the first layer. The liner material may also include a third layer made from an alumina-rich material disposed between the first layer and the second layer. The liner material may also include a fourth layer made from an alumina-rich material such that the second layer is disposed between the third and fourth layers. Optionally the first layer further includes calcined alumina. When included, the first layer's ratio of calcium carbonate to calcined alumina is 7:1 by weight. The first layer may further include at least one dopant.

In still another aspect, a lining material for use in kilns includes a first layer made from an alumina-rich material comprising calcined alumina and a second layer made from a silica-rich material comprising quartz where the second layer is at least as thick as the first layer. The alumina-rich material optionally includes calcium carbonate. A third layer made from an alumina-rich material comprising calcined alumina such that the second layer is disposed between the first layer and third layer may also be included.

### BRIEF DESCRIPTION OF THE DRAWINGS

FIG. 1 is a partial cross sectional perspective view of a kiln shelf liner according to one embodiment of the disclosed technology.

FIG. 2 is a partial cross sectional perspective view of a kiln shelf liner according to another embodiment of the disclosed technology.

FIG. 3 is a perspective view of a liner on a kiln shelf according to the embodiment of the disclosed technology shown in FIG. 1.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

In recent years it has become acceptable to use gypsum board, or sheetrock, as a kiln shelf protector. This provides some advantages, such as minimal friction between the piece and the kiln shelf to allow for shrinkage, but it tends to introduce sulfur from the decomposition of the gypsum (CaSO₄) which can adversely affect certain ceramic glazes. In addition, there can be sulfur emissions (in the form of SOₓ) from the kiln during firing. This approach is also single-use and the remains of the sheetrock are removed by sweeping and vacuuming after firing.

Previous work, conducted over the past 20 years, has clearly documented the range of glass formation possible for aluminosilicate glasses. This work incorporated work on porcelain and stoneware bodies, as well as ceramic glazes, and a broad range of glass compositions. In addition, extensive work has been conducted on glazes in general, specifically focused on the development of glazes for lower temperature firings and the alteration of high-temperature glazes to maintain their texture and character at lower temperatures. There are literally hundreds of glaze compositions within the art ceramics world in addition to a great number of glazes for commercial potteries, as well as glazes sold by art supply companies.

The behavior of the glaze can be altered by changing the composition of the glaze. In the case of glazes produced by studio potters and students in art programs, composition is frequently driven by esthetics, not by the melting behavior. A survey of over 100 glazes, compiled over the time frame of 2000-2005 demonstrated that there was essentially no correlation of the glaze melting behavior with the glaze chemistry. Glazes carried colorful names, such as “Pete's Red” or “John's Runny Sky Blue Gloss” referring to the person that developed the glaze and the glaze character. These names frequently contained an additional moniker—a pyrometric cone value—that designated the firing temperature of that glaze. For example, “John's Runny Sky Blue Gloss” is more completely listed as “John's Cone 10 Sky Blue Gloss”, with Cone 10 denoting the firing temperature. When analyzing “John's Cone 10 Sky Blue Gloss”, it became apparent that this was actually an over-fired Cone 04 gloss glaze that runs (flows) because Cone 10 is almost 300° C. above the melting point ideally suited for a Cone 04 glaze. The result of this over-firing is that this glaze runs off of the ceramic body causing sticking of the piece and damage to the kiln shelf. Artists use glazes that are sometimes not ideal for the kiln conditions, but they use them because they embrace the esthetics provided by the drips and runs of a glaze during firing.

Low viscosity glazes are resisted better by silica than by alumina which is found in most commercial kiln washes. Low temperature glazes typically have low silica levels and sometimes use boron to reduce the melting temperature and improve the flow of the glaze. Boron is quite effective at reducing the melting point of a composition but also causes a reduction in the viscosity at high temperature, thereby assisting in glaze movement or running. Boron helps the fluxes (alkali, such as Li₂O, Na₂O, or K₂O, or alkaline earth oxides such as MgO, CaO, SrO, BaO and also FeO, and ZnO) reduce the melting point of silica, thus creating liquid at lower temperature. Silica (SiO₂) however, is highly soluble in a glaze. As a composition dissolves silica, the viscosity of the resulting melt increases exponentially. Even a small amount of silica addition can have a dramatic impact on the glass viscosity. In addition, silica in the form of quartz will readily dissolve into a melt deficient in silica (or high in flux and boron, or just high in flux—no boron required). Therefore, quartz would appear to be the ideal material for a kiln wash. Concerns, however, over reaction of quartz with kiln atmosphere (such as in a salt (NaCl) or soda (Na₂CO₃ or soda ash) firing), and concerns over crystalline silica, have limited its effective use in kiln wash compositions.

While alumina increases the viscosity of this melt, the solubility of alumina is very limited in a silicate melt, even one with high boron and flux levels. For zircon, however, the solubility is almost zero, so it provides very limited, if any, protection. This lack of solubility in a glaze is why zircon (ZrO₂·SiO₂) is an effective opacifier for ceramic glazes. One erroneous perspective within the art community assumes that having a highly refractory (i.e., high melting point) inert material (such as zircon) would provide effective solution to the glaze drip problem. In practice this is not the case.

Assuming that a running glaze makes it through the alumina-rich kiln wash, a condition frequently observed with dripping glazes, providing a glaze-absorbing layer underneath the alumina-rich kiln wash, provides a functional chemical and physical barrier to halt the migration of the running glaze and thus protecting the kiln shelf. The disclosed invention utilizes sacrificial sheets which absorbs any glaze running off of a ceramic piece during firing, preventing the glaze from reaching a kiln shelf allowing for easy removal of the fired piece after the kiln cycle. In one example the disclosed sheets are a composite of two or more thin sheets of an alumina-rich composition sandwiching a sheet that is silica-rich. These sheets can be manufactured in a variety of thicknesses and sizes and are flexible, easy to cut to a custom size/shape, and safe to handle.

In the chemistry of the glasses formed during the firing of porcelain, results indicate that while 1.2 moles of alumina per mole of flux (Na₂O, K₂O, CaO, etc.) were soluble in the glass, 12-17 moles of silica could dissolve in an alkali-aluminosilicate glass.

As a related example, high-alumina refractory brick are typically used to construct salt and soda kiln linings. The assumption was that the high alumina level would resist the attack of the gaseous sodium vapor formed at temperatures above 900° C. This vapor is the goal of salt and soda firings—the gaseous fluxing species in the kiln atmosphere react with the surface of the ware creating beautiful esthetic affects that are difficult, if not impossible, to create in any other manner. The volatile sodium (Na), however, also aggressively attacks the refractory brick eventually leading to the formation of a crusty surface that flakes off, often falling onto the ceramic ware (an undesirable result). Within a short time, the bricks start to deteriorate to the point of failure often leading to the collapse of the kiln lining. The typical lifetime for a salt kiln was 1-2 years, at which point the kiln would be dismantled and re-built with new refractory brick. Commercial washes, based on zircon, were developed but as explained previously were understandably essentially ineffective at preventing sodium attack of the refractory. Under the assumption that the sodium wanted to react with silica (rather than alumina), and thus would form a high-viscosity glass on the surface of the brick by reaction with the volatile sodium, a simple wash was created, consisting of 15% clay and 85% quartz. This suspension was sprayed on the brick surfaces in the interior of the kiln. The result was the formation of a durable glaze layer that protected the brick—an in situ refractory coating formed. The result of this experiment was that the kiln lining lasted nine years, an improvement of almost 5× over uncoated brick.

In one embodiment the disclosed invention is a sheet of high silica content sandwiched between sheets of alumina-rich material. In a two-layer embodiment, a sheet of alumina-rich material is disposed on top of a sheet of high silica content material. The alumina layer on top protects the silica from atmospheric attack. An optional alumina layer on the bottom reduces the potential for silica reaction with residual glass and glaze drips from previous firings and minimizes the potential for the silica to react with the kiln shelf directly. The silica layer provides a “sink” for the high alkali and high boron molten liquid (glass) that runs off of the pot, capturing the glaze drips and rendering them harmless.

The composition of the alumina layer can be from 5-25% clay with the balance calcined alumina. The composition of the silica layer is 10-50% clay with the balance quartz by weight. A 200-mesh quartz or 325 mesh quartz powder is sufficient, although other particle sizes can be used. Introducing a finer silica has limited benefit but has potential problems with dust formation. Working with a coarser silica, such as silica sand, risks reducing the reactivity of the silica layer and thus making this layer less efficient at absorbing glaze drips.

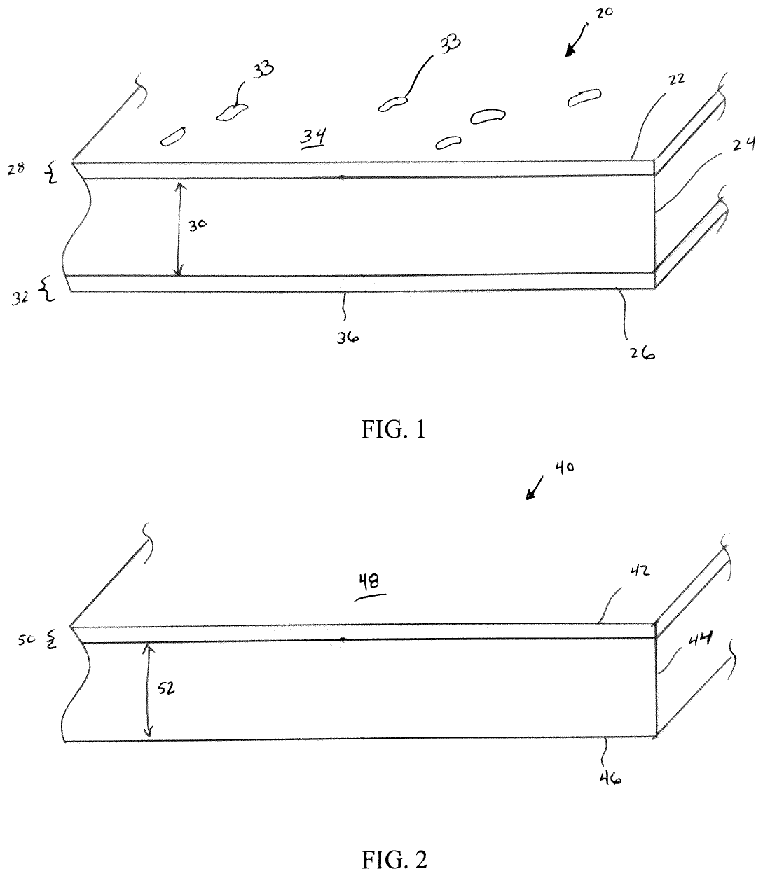

The alumina layers in one example are between 0.2 to 1.0 mm thick. The silica layer may be between 1 and 8 mm thick. (FIG. 1.) These layers may contain an organic polymer which serves as a binder, such as is used in tape casting (e.g., silicone-based polymers, such as polysiloxanes and polysilazanes, cellulose ethers, polyvinyl alcohols, latexes, and the like). This organic binder would burn out in the initial stages of the heat treatment process and not contribute significantly to the kiln exhaust. These sheets may be produced by tape casting or a modified tape casting process, such as high-shear compaction. The three sheets are laminated together in a second high-shear compaction step, or potentially with the application of warming heat (less than 100° C.), in a subsequent step or could be co-cast at one time in a tape casting or high-shear compaction process.

Sheets are dried to create a flexible rubber-like sheet that may be used whole or cut to size producing a coaster-like cookie that “fits” the bottom of the ceramic piece. Optionally, the sheets may be custom cut to fit individual kiln shelves. After firing the sheet could be left on the kiln shelf (if intact) or removed using a vacuum cleaner. It should not be necessary to use a scraper or other abrasive means to remove any remaining sheet or residue. The color of the composite kiln shelf protective sheet could be tailored to the application through the addition of stains or other colorants to match more closely that of the actual ware. It is anticipated that the colorant levels will be low, less than 10% by weight, and would not therefore negatively impact the ability of the composite to react with glaze drips to prevent migration to the kiln shelf.

In another embodiment, tapes of calcium carbonate (whiting, limestone, or CaCO₃) could be produced to serve as “wadding” for pieces destined for a wood kiln or soda kiln. This CaCO₃ layer could be the top layer, replacing the alumina layer, or could be an additional layer, on top of the alumina layer, creating a four-layer structure. The CaCO₃ could also be incorporated into the alumina layer, at a CaCO₃:alumina ratio of at most 10:1, but preferably 8:1 and more preferably 7:1 with the ratio selected to obtain optimal particle packing in the top layer. The whiting particles should be coarse, typically at most a 200 mesh whiting, but preferably a 100 mesh whiting, and a small particle size calcined alumina, that it at least 10× smaller than the whiting particles.

Wadding serves to lift the piece off of the kiln shelf to allow better atmosphere interaction with the piece and to minimize sticking of the piece to the kiln shelf. In addition, wadding can be used to support a lid on a jar, while keeping it aligned with the jar itself, or can be used to support a piece during firing. Seashells are sometimes used for this purpose but these pieces are typically glued to the piece prior to firing. This material would be formed in a similar manner, via roll compaction, of similar thicknesses, that would also be flexible and easy to cut and work with. It could also be cut into small “dots” or pads optionally with a self-adhesive backing, such as is commonly used for hook and loop fastener strips, thus eliminating the need to glue the dots on the piece. This would also be a mixture of 10-20% clay with the balance whiting. This material could also be used as a protective kiln sheet, in a manner similar to the composite alumina-silica sheet. A composite ceramic sheet, produced by tape casting or high-shear compaction, or a combination of these two techniques, sandwiching a high-silica layer between two thin layers of alumina to provide an effective barrier to kiln shelf attack by glaze drips and runs created in the firing of ceramic pottery and sculptural wares.

The disclosed invention may typically be used for the protection of kiln shelves from glaze drips and attack by gaseous chemistry in salt and soda firing. Smaller pieces could be used as wadding for salt and wood firing, but also as protective sheets for the kiln shelf. This sheet could be used for electric, gas, salt, soda, or kiln firings and for functional and sculptural ceramic wares. This could also be used for the firing of advanced ceramic materials to minimize contamination of the ware by reaction with the kiln shelf. Other suitable uses in kilns are also contemplated.

In applications such as soda, salt, or wood firing, it is well known that small chemistry differences can create a situation called “flashing” in which colors appear on the fired ware that are usually unpredictable. It is possible to add small amounts of other chemicals, known as dopants, to the top layer that locally provide chemistry that could contribute to flashing. These chemicals include Li, Na, K, Rb, Mg, Sr, Ba, Ti, V, Cr, Mn, Fe, Co, Ni, Cu, Zn, and Sn. The addition levels are between 0.05 and 2.5% (by weight) and could be added as an oxide (such as Cr₂O₃, etc.), or as a carbonate (such as Na₂CO₃, BaCO₃, CoCO₃, etc.), or as a salt (such as Co(NO₃)₂, CoCl₂, MnCl₂, CuSO₄, etc.).

A kiln shelf liner 20 according to one embodiment of the disclosed invention is shown in FIG. 1. In this particular example the kiln shelf liner 20 includes a first/upper layer 22, a second/middle layer 24, and a third/bottom layer 26. The first layer 22 and third layer 26 are made from alumina-rich material(s) such as previously described. Optionally the first/upper layer 22 may include one or more dopants 33 such as previously described. The second layer 24 is made from silica-rich material(s) such as previously described. The exact thickness of each layer may vary as desired, but the second/middle layer 24 will typically be similar to, or thicker than, the first 22 and third 26 layers. In one example, the first 22 and third 26 layers have a thickness 28, 32 of 0.2-1.0 mm. Optionally they are the same thickness 28, 32 as each other which makes installation and manufacturing easier, but they may be different thicknesses from one another if so desired. In some examples, the first 22 and third 26 layers may be made from materials having different compositions as well as different thicknesses. The second/middle layer has a thickness 30 of 1-8 mm in one example. Several factors may be considered when determining the desired thickness of each layer including, but not limited to, weight/flexibility of final shelf liner, ease of cutting final shelf liner to fit on a desired kiln shelf, expected weight/composition of bodies being fired and/or glaze(s) to be used.

The kiln shelf liner 20 in this particular example includes a first surface 34 and a second surface 36. In examples where the first layer 22 and third layer 26 have the same composition and thickness the orientation of the liner 20 when installed on a kiln shelf is not important. That is, as shown in FIG. 1 the shelf liner 20 may be installed such that the first layer 22 is oriented facing up and ceramic bodies to be fired are placed on first surface 34 whereas the third layer 26 is oriented facing down such that second surface 36 rests on a kiln surface/shelf. The shelf liner 20 may also be installed such that the third layer 26 is oriented facing up and ceramic bodies to be fired are placed on second surface 36 whereas the first layer 22 is oriented facing down such that first surface 34 rests on a kiln surface/shelf. In other examples where the first layer 22 and third layer 26 are of different compositions and/or thicknesses the desired orientation of the kiln shelf liner 20 may be important. In such examples, surfaces 34 and/or 36 may include indicia and/or be color coded to indicate the correct installation orientation. For example, surface 34 may be marked as “This Side Up” and/or surface 36 may be marked as “This Side Down”.

A kiln shelf liner 40 according to another embodiment of the disclosed invention is shown in FIG. 2. In this particular example the kiln shelf liner 40 includes a first/upper layer 42 having a thickness 50 and a second/bottom layer 44 having a thickness 52. The first layer 42 is made from alumina-rich material(s) such as previously described and the second layer 44 is silica-rich materials as previously described. When the shelf liner 40 is installed in a kiln surface 48 is oriented facing up and ceramic bodies to be fired are placed thereon whereas surface 46 is oriented facing down such that surface 46 rests on a kiln surface/shelf.

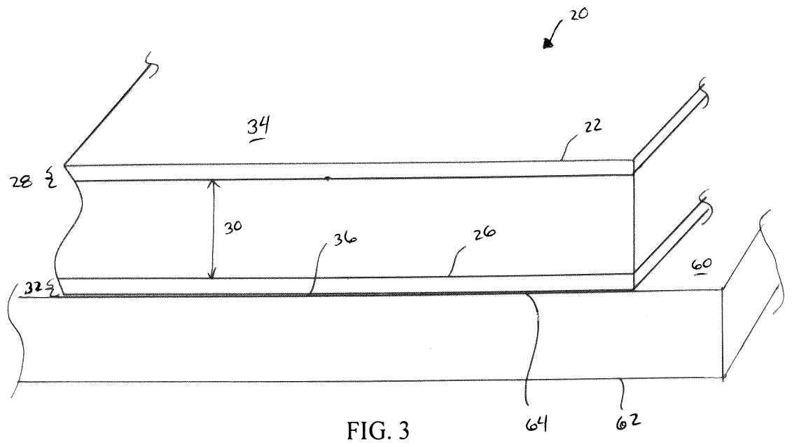

FIG. 3 is a perspective view of kiln shelf liner 20 as shown in FIG. 1 in use on a kiln shelf 62. The kiln shelf 62 has a surface 60 on which objects being fired normally rest. The kiln shelf liner 20 as previously described is optionally trimmed to a desired size then placed on the kiln shelf 62 such that the second surface 36 rests on the shelf surface 60 and glazed objects to be fired are placed on the first surface 34. Optionally additional layers may be included in other examples which combine one or more of the layers/compositions such as previously described.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A liner for a kiln shelf, comprising:
a first layer made from an alumina-rich material; and
a second layer made from a silica-rich material;
wherein the second layer is thicker than the first layer.

2. The liner for a kiln shelf of claim 1, wherein the second layer is at least 3× thicker than the first layer.

3. The liner for a kiln shelf of claim 1, wherein the alumina-rich material is a mixture of clay and calcined alumina.

4. The liner for a kiln shelf of claim 3, wherein the alumina-rich material is 75-95% calcined alumina.

5. The liner for a kiln shelf of claim 3, wherein the alumina-rich material further includes calcium carbonate.

6. The liner for a kiln shelf of claim 3, wherein the alumina-rich material further includes an organic polymer binding agent.

7. The liner for a kiln shelf of claim 1, wherein the silica-rich material is a mixture of clay and quartz.

8. The liner for a kiln shelf of claim 7, wherein the silica-rich material is 50-90% quartz.

9. The liner for a kiln shelf of claim 7, wherein the alumina-rich material further includes an organic polymer binding agent.

10. The liner for a kiln shelf of claim 1, further comprising a third layer made from an alumina-rich material such that the second layer is disposed between the first and third layers.

11. The liner for a kiln shelf of claim 1 wherein the first layer further includes at least one dopant.

12. A liner for a kiln shelf, comprising:
a first layer made from a calcium carbonate-rich material; and
a second layer made from a silica-rich material;
wherein the second layer is at least as thick as the first layer.

13. The liner of claim 12, further comprising a third layer made from an alumina-rich material disposed between the first layer and the second layer.

14. The liner for a kiln shelf of claim 13, further comprising a fourth layer made from an alumina-rich material such that the second layer is disposed between the third and fourth layers.

15. The liner of claim 12 wherein the first layer further includes calcined alumina.

16. The liner of claim 15 wherein the first layer is comprised of a material having a ratio of calcium carbonate to calcined alumina of 7:1 by weight.

17. The liner for a kiln shelf of claim 12 wherein the first layer further includes at least one dopant.

18. A lining material for use in kilns, comprising:
a first layer made from an alumina-rich material comprising calcined alumina; and
a second layer made from a silica-rich material comprising quartz;
wherein the second layer is at least as thick as the first layer.

19. The lining material of claim 18 wherein the alumina-rich material further includes calcium carbonate.

20. The lining material of claim 18, further comprising a third layer made from an alumina-rich material comprising calcined alumina such that the second layer is disposed between the first layer and third layer.
